(19) United States
(12) Patent Application Publication
(10) Pub. No.: US 2023/0333253 A1
(43) Pub. Date: Oct. 19, 2023

(54) LIDAR POINT CLOUD DATA ALIGNMENT WITH CAMERA PIXELS

(71) Applicant: Avanti R&D, Inc., Torrance, CA (US)

(72) Inventors: Dustin Gyurina, Carson, CA (US); Go Yuasa, Rancho Palos Verdes, CA (US)

(21) Appl. No.: 18/295,650

(22) Filed: Apr. 4, 2023

Related U.S. Application Data
(60) Provisional application No. 63/330,609, filed on Apr. 13, 2022.

(51) Int. Cl. G01S 17/894; G01S 17/86; G06T 7/80

(52) U.S. Cl. CPC G01S 17/894; G01S 17/86; G06T 7/80; G06T 2207/10028

(57) ABSTRACT

A computer vision apparatus for detecting an object within a surrounding environment comprises an optical camera sensor, a lidar sensor, a first buffer memory, a second buffer memory and a CPU, wherein the computer programs comprise the steps of capturing image data of the object via the optical camera sensor, storing the captured image data into the first buffer memory, scanning the object using the lidar sensor, storing scanned point cloud data into the second buffer memory, identifying a moving object, assigning an identification code (ID) to the moving object, obtaining information including the ID, position, speed, and time stamp when the moving object passes a certain point in a camera view; and matching an incoming moving blob corresponding to the moving object using the information received by the camera sensor when the incoming moving blob passes a certain point in a lidar view.

This non-provisional application claims priority from U.S. Provisional Patent Application Ser. No. 63/330,609 filed, 04/13/2022, the contents of which are incorporated herein by reference in its entirety.

### TECHNICAL FIELD OF THE INVENTION

The present invention relates to a technical field of a computer vision apparatus for detecting and tracking objects within a surrounding environment.

### BACKGROUND OF THE INVENTION

Many computer vision apparatuses use lidars and/or camera sensors with computer vision algorithms to detect and track objects within a surrounding environment. One of the main advantages of a lidar is that the light source is integrated therein. The lidar uses an eye-safe laser to emit laser pulses which light up a desired area. Unlike cameras, the lidar functions independently of the ambient lighting by illuminating laser rays emitted from the lidar itself. However, the lidar gives a much higher surface density compared to images captured by the camera sensor in general. However, lidar cannot identify the color differences. On the other hand, camera sensors can identify the color differences and recognize the characters such as numbers in the license plate on the vehicle as images, for example. To utilize those sensors, the advantages of lidar and camera sensors should be effectively combined.

### SUMMARY OF THE INVENTION

In an embodiment of this invention, a computer vision apparatus for detecting and tracking an object within a surrounding environment, the computer vision apparatus comprises an optical camera sensor for obtaining image data of the object, a lidar sensor for obtaining point cloud data of the object, a first buffer memory for storing the image data from the optical camera sensor, a second buffer memory for storing the point cloud data from the lidar sensor, a CPU (Central Processing Unit) on which computer programs run thereon, the computer programs being arranged to control the optical camera sensor and the lidar sensor; and a memory for storing the computer programs, wherein the computer programs comprise the steps of capturing image data of the object via the optical camera sensor, storing the captured image data into the first buffer memory, scanning the object using the lidar sensor, storing scanned point cloud data via the lidar sensor into the second buffer memory, identifying a moving object in the first buffer memory or a moving blob in the second buffer memory, assigning an identification code (ID) to the moving object in the first buffer memory, obtaining information including the ID, position, speed, and time stamp when the moving object passes a certain point in a camera view of the camera sensor; and matching an incoming moving blob corresponding to the moving object by using the information received by the camera sensor when the incoming moving blob passes a certain point in a lidar view corresponding to the certain point in the camera view.

According to an embodiment of this invention described above, it becomes possible to effectively combine the benefits of using both lidar and optical camera sensor as a shared input to the computer vision apparatus. For example, uncertain recognition elements due to camera sensor performance limitation, such as car classification recognition at night, can be compensated for by lidar's performance, and the content recognized by the camera sensors can be updated.

In another embodiment of this invention, a computer vision apparatus for detecting and tracking object within a surrounding environment, the computer vision apparatus comprises an optical camera sensor for obtaining image data of the object, a plurality of lidar sensors for obtaining point cloud data, the plurality of lidar sensors including a first lidar sensor and a second lidar sensor, a first buffer memory for storing the image data from the optical camera sensor, a second buffer memory for storing the point cloud data from the plurality of lidar sensors, a CPU (Central Processing Unit) on which computer programs run thereon, the computer programs being arranged to control the optical camera sensor and the plurality of lidar sensors, and a memory for storing data associated with the computer programs, wherein the computer programs comprise the steps of, capturing the image data of the objects via the optical camera sensor, storing the captured image data into the first buffer memory, scanning the object via the first lidar sensor, scanning the object via the second lidar sensor, wherein the scanning via the second lidar sensor is phase-shifted from the scanning via the first lidar, merging cloud data from the first lidar sensor and cloud data from the second lidar sensor, storing the merged cloud data into the second buffer memory, synchronizing position of objects identified by the optical camera sensor and the plurality of lidar sensors, performing parallel pre-process data in the first buffer memory and the second buffer memory independently using independent blob detection algorithms, estimating sizes and shapes of the objects stored in the first buffer memory and the second buffer memory when the computer programs identify a moving blob or a moving object in the first buffer memory and the second buffer memory; and overlaying a position of the image data onto a position of the moving blob so that a remaining view area can be matched to a remaining view area can be matched to view area of the other sensors.

According to an embodiment of this invention described above, it becomes possible to increase effective lidar scanning rate by increasing phase-shifting lidar scan rate of the lidar sensors instead of raising scanning frequency which has a certain limitation.

### BRIEF DESCRIPTION OF THE DRAWINGS

FIG. 1 illustrates a computer vision apparatus including camera sensors, lidar sensors, a CPU on which computer programs for controlling thereof run, buffer memories and a memory on which the computer programs are stored.

FIG. 2 illustrates a field of view of a lidar sensor (lidar sensor view), and an object viewed in the field of a detector of the lidar sensor.

FIG. 3 illustrates a field of view of a camera sensor (camera sensor view) and an object viewed on the detector of the camera sensor.

FIG. 4 illustrates a field of view on which the field of view of a lidar and the field of view of a camera sensor are combined.

FIG. 5 illustrates an example of concept of phase-shift of scan starting times between two lidar sensors with 20 Hz lidar scan rate.

FIG. 6A illustrates an example of point cloud data obtained by a lidar sensor 1 having 20 Hz lidar scan rates shown in FIG. 5.

FIG. 6B illustrates an example of point cloud data obtained by a lidar sensor 2 having 20 Hz lidar scan rates on which the scan starting time is shifted from the lidar sensor 1 shown in FIG. 5.

FIG. 6C illustrates an example of merged point cloud data from lidar sensor 1 and lidar sensor 2 illustrated in FIG. 5.

FIG. 7 illustrates an example of vehicles on the road viewed by the camera sensor.

FIG. 8 illustrates an example of vehicles on the road viewed by the lidar in a different view angle from the view illustrated in FIG. 5.

### DETAILED DESCRIPTION OF THE INVENTION

### Embodiment 1

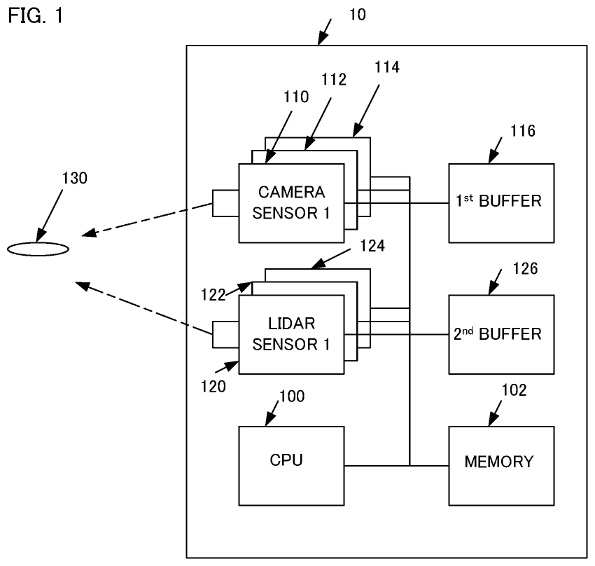

FIG. 1 illustrates an embodiment 1 of the invention being a computer vision 10 configured by camera sensors 110, 112 and 114, lidar sensors 120, 122, 124, a first buffer memory 116 for storing image data captured by the camera sensors 110, 112 and 114, a second buffer memory 126 for storing image data captured by the lidar sensors 120, 122 and 124, a CPU (Central Processing Unit) 100 and Memory 102 on which computer programs for controlling the optical camera sensors 110, 112 and 114 and the lidar sensors run.

The camera sensors 110, 112 and 114 capture an image of an object 130. The lidar sensors 120, 122 and 124 are arranged to irradiate laser rays onto the object 130 and receive reflected laser rays coming back from the object 130 to the lidar sensors 120, 122 and 124. Lidar sensors 120, 122 and 124 use an eye-safe laser to emit laser ray pulses which light up the desired area in this embodiment. A lidar sensor has the capability for calculating distances by measuring the time for a signal to return using appropriate sensors and data acquisition electronics. On the other hand, the camera sensors 110, 112 and 114 can recognize the color and character numbers of the license plate on vehicle by applying computer programs running on the CPU 100, for example. In this embodiment 1, video cameras are used as camera sensors 110, 112 and 114. However, the computer vision 10 can be configured by a single camera sensor and/or a single lidar sensor.

The camera sensors 110, 112 and 114 capture image data of an object 130 and store the image data to the first buffer memory 116. The lidar sensors 120, 122 and 124 obtain point cloud data including the shape and a size information of object 130 and store the point cloud data into the second buffer memory 126 under the computer programs running on the CPU 100. In this embodiment, plural camera sensors and a plurality of Lidar sensors are used. However, a single camera sensor and a single lidar can be used in this embodiment. In this embodiment, a rotation mechanism is included in the lidar sensor. However, a non-rotational usually referred to solid-state lidar sensors can also be used.

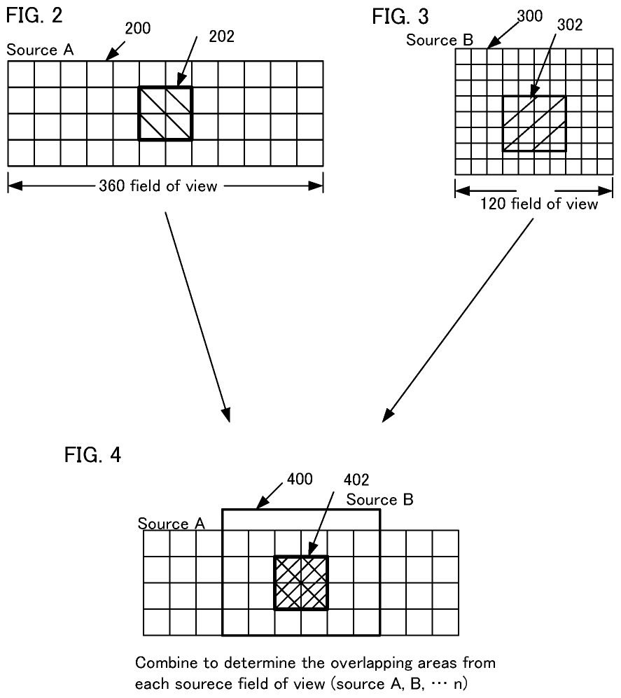

All these functions described above, and functions described below for controlling camera sensors 110, 112 and 114 and lidar sensors 120, 122 and 124 are performed under the control of the computer programs running on memory 102 together with CPU 100. The computer programs can synchronize capturing flame data on the first buffer 116 and data scans on the second buffer 126 by using a global time source such as PTP (Precision Time Protocol) or any global timestamp. [0010] FIG. 2 illustrates a field of view 200 of the laser Rx optical receiver (Source A) on which received laser signals or ambient light signals (limited light frequency and pixel resolution) as illustrated in left-handed slanting lines by the lidar sensors 120, 122 and 124. The lidar sensors 120, 122 and 124 are designed to irradiate laser rays by rotating a laser-head so that the moving object can be identified in the background (360 degrees). The field of view 200 is configured by 360 degree-field of view as illustrated in FIG. 2.

FIG. 3 illustrates a field of view of camera optical receiver of the camera sensors 110, 112 and 114 (Source B). In this embodiment, the camera sensors have 120 degree-viewing angles. As illustrated in FIG. 3, an ambient area 302 as illustrated in right-handed slanting lines is shown on field of view 300 (120-degree field of view).

FIG. 4 illustrates a field of view on which the field of view of a lidar sensor (Source A) and the field of view of a camera sensor (Source B) are combined to determine the overlapping areas from each source of field of views (Sources A and B) in this embodiment, but not limited to two sources, they may be three or more sources). Followings are detailed procedures of the overlapping process.

The computer programs perform parallel pre-process of the data from camera sensors 110 112 and 114 and lidar sensors 120, 122 and 124 by utilizing an independent blob detection algorithm. When the computer programs recognize an identified blob or a moving object in both buffer memories 116 and 126, then the computer programs estimate the blob size and shape independently on each sensor data.

Then, the computer programs compare the detected blob shape and size from each sensor buffer 116 and 126 to match the location of camera pixels with existing blob and the point cloud data of the existing blob. The computer programs are arranged to overlay the position of the blob detected by each sensor as illustrated in FIG. 3. Finally, computer programs match the remaining area to the view area of the other sensors to know the common view area of the other sensors.

Instead of the lidar utilizing laser ray, a lidar sensor using ambient light (optical) sensor can be used in this embodiment. In this case, elements of scene can be identified by using lidar optical sensor. The elements can be matched to pixels on separate camera sensors. In this case, three-dimensional points of cloud data from the lidar sensor are matched to two-dimensional pixel map from the camera sensor. In this case, PTP (Precision Time) protocol or any global timestamp can be used to align time of pixel frame rate with lidar scan rate.

The confidence of objects detected by lidar point cloud data can be increased by comparing the blob or object as detected using ambient light sensor data from camera or lidar ambient light sensor. In the case where the reflectivity of an object is low, such as black color vehicles, it may be possible to observe the ambient light from the same object since the light source may be reflected from a different angle, color, or intensity compared to the source position of the laser from a lidar sensor.

Adjustable Start Scan Timing of Prural Lidar Sensors

Next, an embodiment including plural lidar sensors having capability of adjustable start scan timing will be described. A plurality of lidar sensors can be phased locked by internal configuration of each lidar sensor that enables an adjustable start scan timing relative to another lidar sensor with respect to the external clock source such as PTP grandmaster clock. By offsetting the start of each scan at different times of the grandmaster clock, the total scan rates can be increased by a factor of the number of sensors synchronized by an external clock. This enables faster moving objects to be detected and tracked by a multiple lidar scanning system with phase offsets. Typically, a scanning lidar has limited scan rates of 20 Hz or less. By adding a second lidar with 0 deg azimuth starting scans phase shifted by 180 deg from the first lidar 0 deg azimuth starting scans, for the case where each lidar is scanning at 20 Hz, the total scan rate of an overlapping scene or objects in a shared view can be detected and tracked with a 40 Hz effective scanning rate.

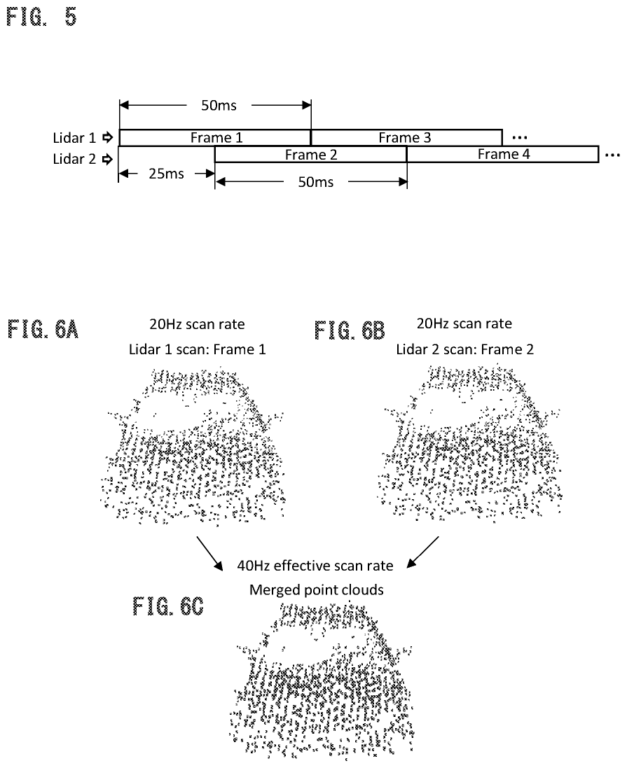

FIG. 5 illustrates an example of 20 Hz lidar scan rate onto which a phase shifting lidar scans is applied. In this example, multiple lidars are configured by lidar 1 and lidar 2 as illustrated in FIG. 5. As illustrated in FIG. 5, the scan starting time of lidar 2 is shifted 25 msecond from the scan starting time of lidar 1, for example, in this example. In this example, the scan shifting time is arranged to be electrically set so that the timing to obtain lidar data from each of the multiple lidar sensors can be adjusted electrically through the data pipeline as illustrated in FIG. 5.

FIGS. 6A, 6B and 6C illustrate captured scan data (point clouds) of obtained from frame 1 of lidar 1 and frame 2 of lidar 2 and the overlayed scan data from frame 1 of lidar 1 and frame 2 of lidar 2. In this example, the point clouds are obtained from the front view of a vehicle.

According to this example even though each lidar sensor 20 Hz lidar scan rates, the effective scan rate can be arranged to be 40 Hz by phase shifting of the Lidar sensors as described above. In this example, the lidar including a rotation mechanism is used. However, lidars can also have non-rotational configurations usually referred to as “solid-state” lidars as described above. In this example, two lidar sensors are used. However, the number of lidar sensors used in the computer vision can be more than two to increase the resolution necessary for the scanning area to be observed.

### Embodiment 2

Sometimes a lidar sensor can have more resolution than a camera sensor depending on view distance and camera pixel amounts relative to the lidar laser beam concentration/angles. The same can be true for camera resolution. In these cases, camera sensor or lidar can aid in pre-tracking an object further away that is not detectable by other sensor with lower resolution.

In the case where a certain area requires high accuracy tracking by lidar but cannot capture entire scene due to view limitation, a camera sensor mounted from same point but looking at a different view (possibly no view overlap) can be used to organize and pre-track objects that are predicted to move into the view of the high resolution lidar. Sort of a short distance re-ID, where data is passed between camera sensor to lidar to allow lidar to re-ID the object and continue tracking it and gain more information because lidar's resolution is higher than that of camera sensor in general.

FIG. 7 illustrates a situation where two vehicles 702 and 704 are passing on the road 700 viewed by a camera sensor. The camera sensor can recognize the color of the image captured by the camera sensor. In this case, both two vehicles 702 and 704 can be recognized by the camera sensor.

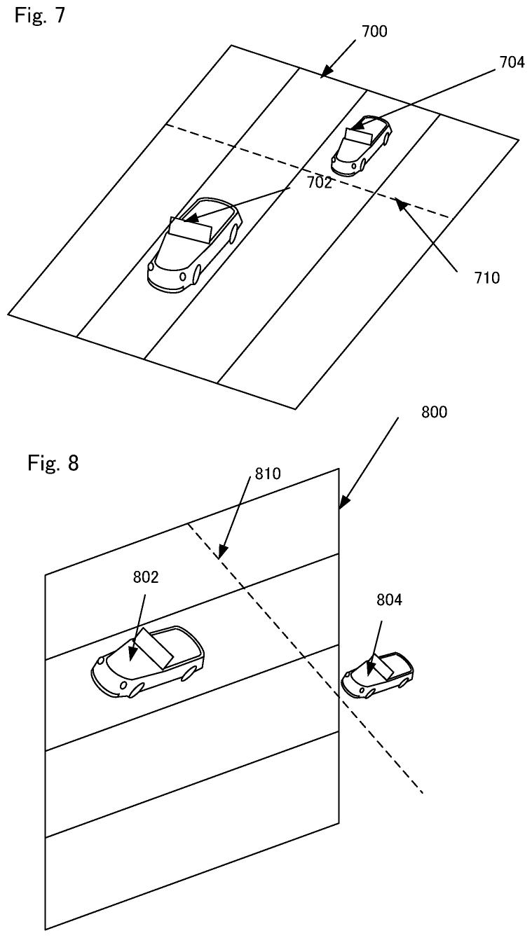

FIG. 8, illustrates an example of vehicles 802 and 804 on the road 800 viewed by a lidar sensor in a different view angle from the view illustrated in FIG. 7. Two vehicles 702 and 704 in FIG. 7 correspond to two vehicles 802 and 804 in FIG. 8 respectively. The camera sensor utilized in FIG. 7 has a wider view than that of the lidar sensor used in FIG. 8 having higher pixel resolution than that of camera used in FIG. 7. In this embodiment, the obtained data by the lidar sensor is 3D (three dimensional) data.

As described above, the vehicle 704 is recognized by the camera sensor. Then, the computer vision apparatus including the camera sensor assigns an ID (Identification Code or Number) to vehicle 704. Further, the computer vision apparatus can calculate speed, direction and estimate distances to the vehicle using camera's setup calibration. As a result, the computer vision apparatus can estimate the position of the tracked object and share distance coordinate information to confirm the position of a detected blob when the vehicle 704 passes a specific location or point, like a virtual line such as a dotted line illustrated in FIG. 7 and records its ID, position, speed, and the timestamp of the vehicle 704.

On laser Rx optical receiver on the lidar sensor used in FIG. 7, the computer vision apparatus including the lidar sensor uses the information received from the camera sensor used in FIG. 7 to match the incoming vehicle 804. Uncertain recognition elements due to camera performance limitations, such as car classification recognition at night, are compensated for by lidar's performance, and the content recognized by the camera can be updated with a second camera sensor (3rd, 4th, etc. to n camera) for as long as the same object is tracked.

In other words, assuming the initially tracked object detected by a camera sensor can remain in view of the camera sensor while the lidar sensor can begin to track the same object, lidar sensor uses information of the object from camera and confirms/corrects the estimated distance values that were estimated by camera sensor. The measured distance values can be more accurately tracked when lidar sensor shares data about the object (including color information known from first camera) and shared.

Embodiment 2 can be performed by using multiple camera sensors and lidar sensors. It becomes possible to define an ID data structure that allows camera sensor and lidar sensors to share information about a tracked object, instead of a numerical ID only.

In embodiments 1 and 2, an electro-mechanical including a rotation mechanism or a solid state lidar sensor or mixed thereof can be used.
10 Computer vision apparatus
100 CPU
102 Memory
110 Camera sensor 1
112 Camera sensor 2
114 Camera sensor “n”
120 Lidar sensor 1
122 Lidar sensor 2
124 Lidar sensor “n”
130 Object
200 Source A view/Laser Rx optical receiver
202 Ambient lights (Limited light frequency and pixel resolution)
300 Source B view/Camera optical receiver)
302 Ambient color lights (Higher pixel resolution (different field of view)
402 Over lapping areas of ambient lights from source A and ambient color lights from source B
700 Road with four lanes
702 Vehicle 1
704 Vehicle 2
800 Road with four lanes
802 Vehicle 1
804 Vehicle 2

What is claimed is:

1. A computer vision apparatus for detecting and tracking an object within a surrounding environment, the computer vision apparatus comprising:
an optical camera sensor for obtaining image data of the object;
a lidar sensor for obtaining point cloud data of the object;
a first buffer memory for storing the image data from the optical camera sensor;
a second buffer memory for storing the point cloud data from the lidar sensor;
a CPU (Central Processing Unit) on which computer programs run thereon, the computer programs being arranged to control the optical camera sensor and the lidar sensor; and
a memory for storing the computer programs,
wherein the computer programs comprise the steps of:
capturing image data of the object via the optical camera sensor;
storing the captured image data into the first buffer memory;
scanning the object using the lidar sensor;
storing scanned point cloud data via the lidar sensor into the second buffer memory;
identifying a moving object in the first buffer memory or a moving blob in the second buffer memory;
assigning an identification code (ID) to the moving object in the first buffer memory;
obtaining information including the ID, position, speed, and time stamp when the moving object passes a certain point in a camera view of the camera sensor; and
matching an incoming moving blob corresponding to the moving object by using the information received by the camera sensor when the incoming moving blob passes a certain point in a lidar view corresponding to the certain point in the camera view.

2. The computer vision apparatus of claim 1,
wherein the computer programs further include the steps of:
updating a classification of the moving object obtained by the camera sensor using those of the lidar sensor when the incoming blob enters the lidar view and has obtained the classification of the moving blob.

3. The computer vision apparatus of claim 2,
wherein the lidar sensor includes a rotation mechanism.

4. The computer vision apparatus of claim 2,
wherein the lidar sensor includes a solid state lidar sensor.

5. A computer vision apparatus for detecting and tracking object within a surrounding environment, the computer vision apparatus comprising:
an optical camera sensor for obtaining image data of the object;
a plurality of lidar sensors for obtaining point cloud data, the plurality of lidar sensors including a first lidar sensor and a second lidar sensor;
a first buffer memory for storing the image data from the optical camera sensor,
a second buffer memory for storing the point cloud data from the plurality of lidar sensors;
a CPU (Central Processing Unit) on which computer programs run thereon, the computer programs being arranged to control the optical camera sensor and the plurality of lidar sensors; and
a memory for storing data associated with the computer programs,
wherein the computer programs comprise the steps of:
capturing the image data of the objects via the optical camera sensor;
storing the captured image data into the first buffer memory;
scanning the object via the first lidar sensor;
scanning the object via the second lidar sensor;
wherein the scanning via the second lidar sensor is phase-shifted from the scanning via the first lidar;
merging cloud data from the first lidar sensor and cloud data from the second lidar sensor;
storing the merged cloud data into the second buffer memory;
synchronizing position of objects identified by the optical camera sensor and the plurality of lidar sensors;
performing parallel pre-process data in the first buffer memory and the second buffer memory independently using independent blob detection algorithms;
estimating sizes and shapes of the objects stored in the first buffer memory and the second buffer memory when the computer programs identify a moving blob or a moving object in the first buffer memory and the second buffer memory; and
overlaying a position of the image data onto a position of the moving blob so that a remaining view area can be matched to a remaining view area can be matched to view area of the other sensors.

6. The computer vision apparatus of claim 5,
wherein the computer programs further comprising the steps of:
assigning an identification code (ID) to the moving object in the first buffer memory;
obtaining information including the ID, position, speed, and time stamp when the moving object passes a certain point in a camera view of the camera sensor; and
matching an incoming moving blob corresponding to the moving object by using the information received by the camera sensor when the incoming moving blob passes a certain point in a lidar view corresponding to the certain point in the camera view.

7. The computer vision apparatus of claim 6,
wherein the computer programs further include the steps of:
updating a classification of the moving object obtained by the camera sensor using those of the plurality of lidar sensors when the incoming moving blob enters the lidar view and has obtained the classification of the moving blob.

8. The computer vision apparatus of claim 7,
wherein the lidar sensor includes a rotation mechanism.

9. The computer vision apparatus of claim 7,
wherein the plurality of lidar sensors includes a solid state lidar sensor.
